(19) United States
(12) Patent Application Publication
(10) Pub. No.: US 2007/0073565 A1
(43) Pub. Date: Mar. 29, 2007

(54) RESOURCE ALLOCATION SYSTEM AND METHOD

(76) Inventors: Dominique D'Heedene, Brussels (BE); Mia Vanstraelen, Bertem (BE)

Correspondence Address: HOFFMAN, WARNICK & D'ALESSANDRO LLC, 75 STATE ST, 14 FL, ALBANY, NY, 12207, US

(21) Appl. No.: 11/468,861

(22) Filed: Aug. 31, 2006

(30) Foreign Application Priority Data
Sep. 2, 2005 (EP) 05300715.9

(51) Int. Cl. G06F 17/50

(52) U.S. Cl. 705/7

(57) ABSTRACT

A resource allocation system including a server and data repository. The data repository stores historic usage data of resources, typically training courses. The server processes resource priority data and the historic usage data to generate a high level resource allocation plan (HLP). The server generates an operational resource allocation plan (OLP) relating to a business unit based upon an analysis of the HLP and local data indicative of the resource allocation requirements the business unit.

### FIELD OF THE INVENTION

The present invention is directed to a resource allocation system and method, and more particularly to a system and method for learning planning.

### BACKGROUND OF THE INVENTION

In current arrangements for the planning and structuring of training in large to medium sized organisations, typically from a few hundred to thousands of employees, employees adopt training schedules in response to needs and skill gaps within their local business environment. Typically, a business unit manager identifies a perceived skills gap within their business unit and arranges for employee training in the requisite skill. This can result in duplicate or contradictory training initiatives either within a business unit or within the organisation. Such duplicate or contradictory training initiatives can lead to inefficient usage of the organisations resources, for example money, people, time, location such as meeting rooms, or computing resources.

An example where duplication of training can occur is where an employee previously trained in an area is overlooked when formulating a training plan. Such duplication of training results in the duplication of records that increase the amount of data transferred and stored upon a business' computer system. The use of remote electronic learning (eLearning) can also require the use of significant bandwidth and data transfer across a network. The duplication of eLearning initiatives can result in the unnecessary use of network bandwidth with a commensurate degradation in network performance.

Typically, the delivery of classroom training is planned based on the knowledge, understanding and sometimes limited information that the responsible training delivery manager has of the business and learning priorities. Also, employees may take training courses based on what is available in the training catalogue.

Additionally, the cost of training employees can represent a significant fraction of an organisations budget. Replication of training is therefore undesirable from a monetary perspective.

There are course scheduling and individual learning planning solutions available. However, these solutions deal only with individual learning needs and do not address the problem of providing a complete, systematic learning flow that is synchronised to the business and market needs. Additionally, the current planning solutions do not account for the monetary cost of training and do not address the affordability of training within the wider business context.

### SUMMARY OF THE INVENTION

According to a first aspect of the present invention there is provided a method of resource allocation comprising: prioritising objective data indicative of objectives of an organisation; generating macro data relating to a macro resource allocation plan relating to resource allocation requirements of the organisation based upon an analysis of the objective data in conjunction with historic resource usage data; and generating micro data relating to resource allocation requirements of an element of the organisation based upon an analysis of the macro data and local data indicative of the resource allocation requirements of the element.

Such a method reduces the replication of resource allocation, thereby reducing the number of records that must be stored relating to resource allocation. This reduces the data storage requirements of a system employing the method and also improves the efficiency of resource allocation over present methods.

According to a second aspect of the present there invention there is provided a resource allocation system comprising: central processing means, data storage means, terminal means, and a network, the data storage means having historic resource usage data stored thereupon, the central processing means being arranged to process resource priority data and historic resource usage data read from the data storage means, the processing means being further arranged to generate macro data relating to a macro resource allocation plan relating to resource allocation requirements of an organisation based upon the historic resource usage data and the resource priority data, the processor being further arranged to generate micro data relating to resource allocation requirements of an element of the organisation based upon an analysis of the macro data and local data indicative of the resource allocation requirements of the element.

According to a third aspect of the present invention there is provided software which, when executed on a processor, is arranged to carry out the method according to the first aspect of the present invention.

### BRIEF DESCRIPTION OF THE DRAWINGS

Reference will now be made, by way of example, to the accompanying drawings.

FIG. 1 is a schematic representation of an embodiment of a resource allocation methodology according to an aspect of the present invention.

FIG. 2 is a schematic representation of phases of the methodology of FIG. 1.

FIGS. 3a and 3b are tabular representations of parameters utilised in an embodiment of a methodology of high level plan (HLP) generation in accordance with an aspect of the present invention.

FIGS. 4 to 7 are flow charts detailing an embodiment of a method of the high level plan (HLP) generation in accordance with an aspect of the present invention.

FIGS. 8a to 8c are representations of the output of the embodiment of the method of high level plan generation of FIGS. 4 to 7.

FIGS. 9a and 9b are tabular representation of parameters used in an embodiment method of operational level planning (OLP) in accordance with an aspect of the present invention.

FIGS. 10 to 14 are flow charts detailing an embodiment of the OLP method of resource allocation according to an aspect of the present invention.

FIG. 15 is a resource allocation system in accordance with an aspect of the present invention.

FIGS. 16a-16e illustrate a competency type table (Table 1).

FIGS. 17a-17e illustrate a market valued skills type table (Table 2).

FIG. 18 illustrates a market valued skills type table (Table 3).

FIG. 19 illustrates a market valued skills type table (Table 4).

FIG. 20 illustrates a market valued skills type table (Table 5).

FIG. 21 illustrates a market valued skills type table (Table 6).

FIG. 22 illustrates a market valued skills type table (Table 7).

FIG. 23 illustrates a market valued skills type table (Table 8).

In an embodiment of the present invention, the generation of training plans is a multi-level operation. Data corresponding to overall business considerations inputs into the generation of a macro, higher level plan (HLP). The HLP is macro in that it relates to the overall training requirements of the general business considerations.

For example, business priorities can be ranked and assigned a parameter value from one to ten. Business priorities are typically described in text format and derived from business strategy. This information is input in order to define learning priorities where a value from 1 to 4 is assigned in the example. The ranking value of each business priority can vary between business units, or can have their ranking value assigned set by a central coordinator in the case of core business priorities.

Typical examples of business priorities include business development, customer support, product quality and value for money.

Data generated in the higher level training plan inputs into generation stage of the second, operational level plan (OLP).

The OLP is an operational learning plan that takes into account such factors as historic employee training data, resource data and master learning solutions.

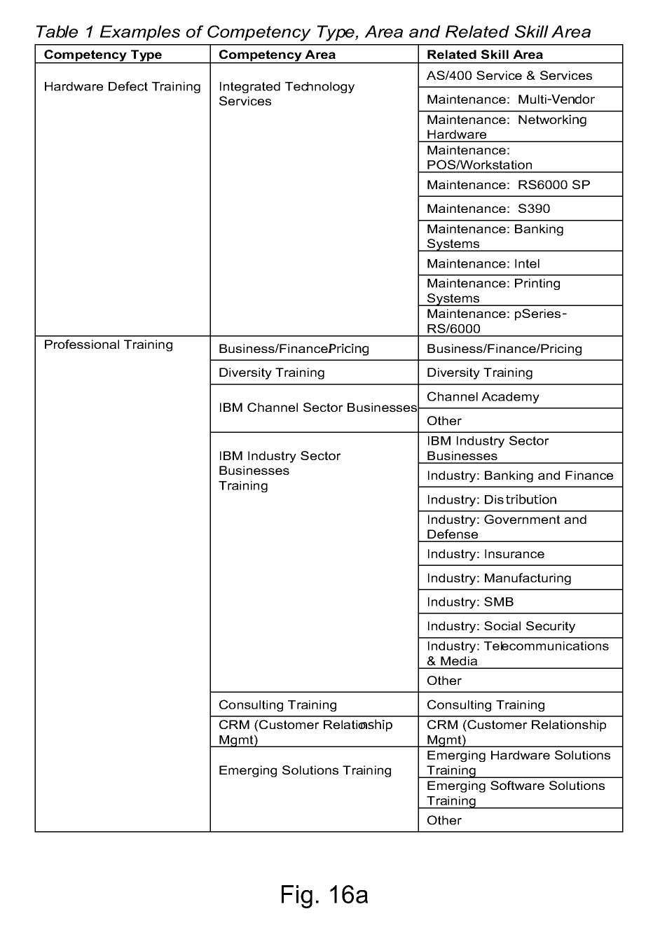

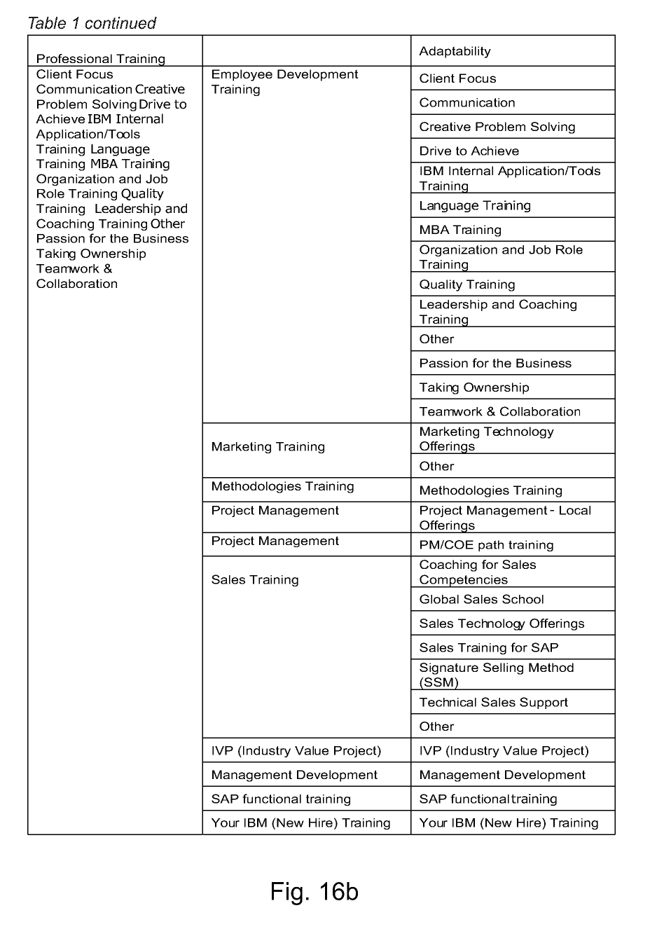

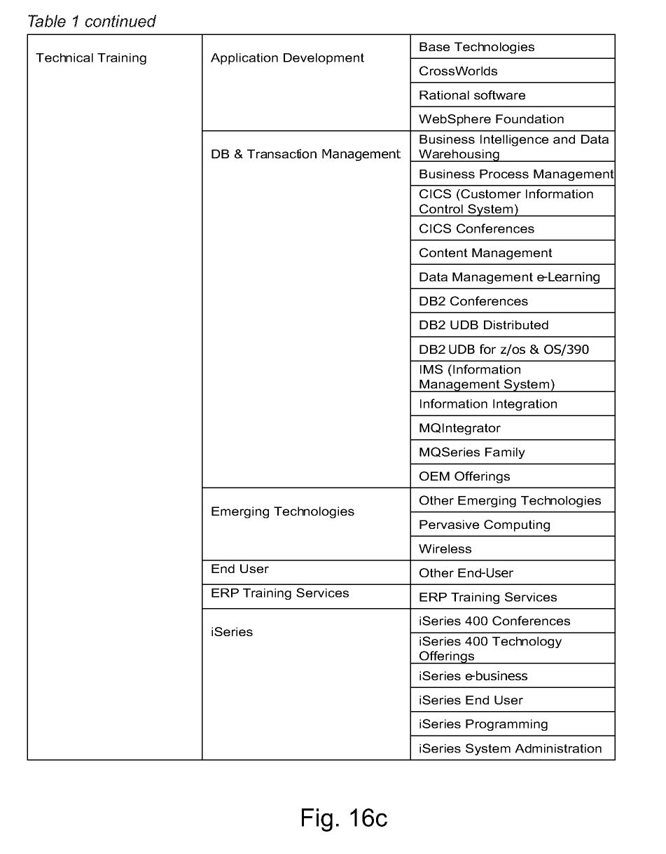

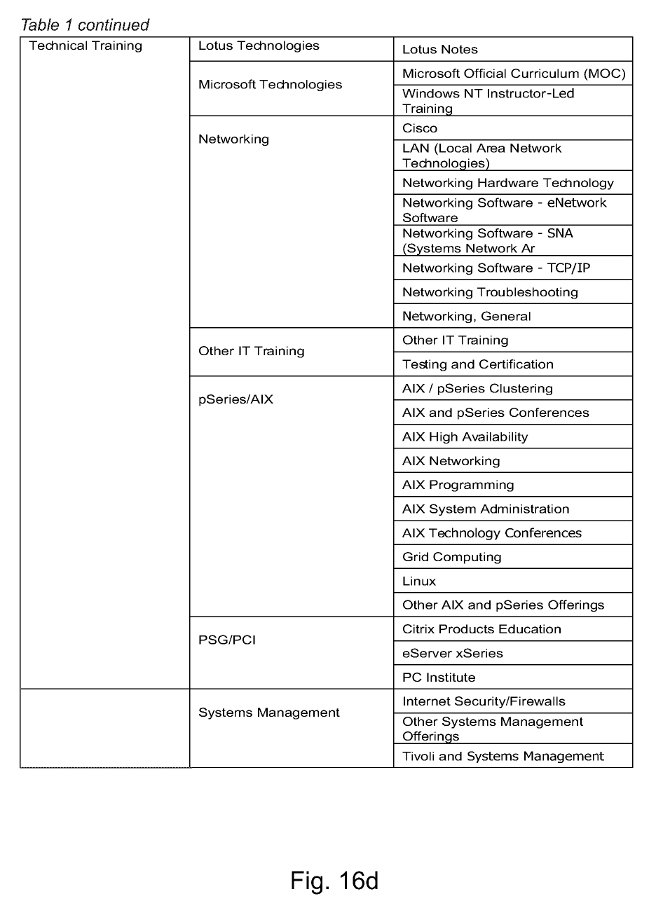

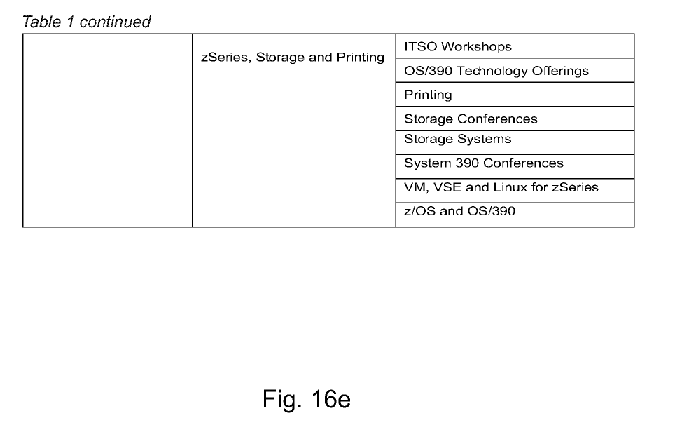

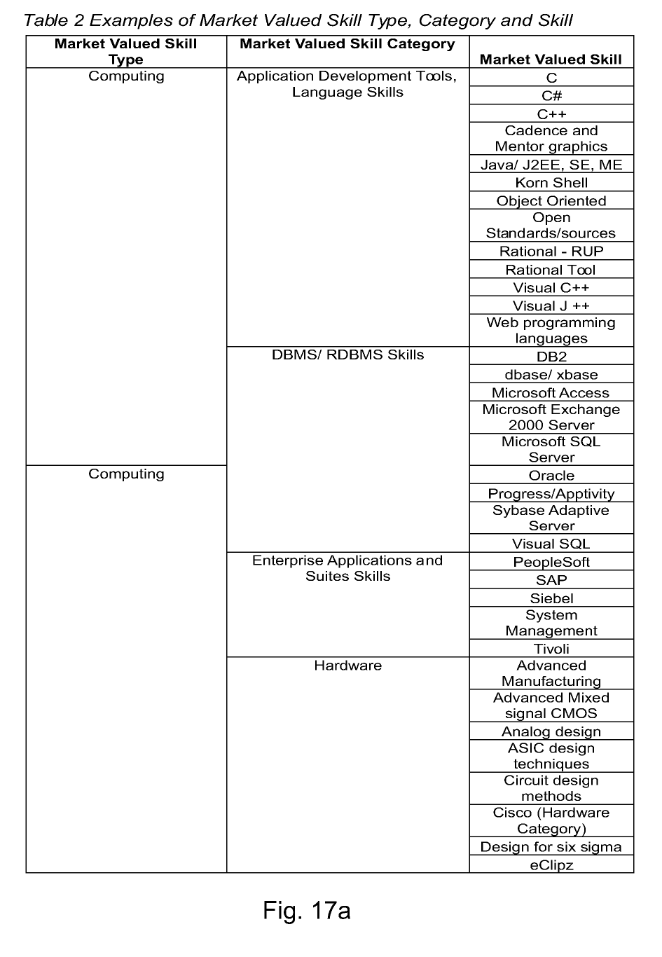

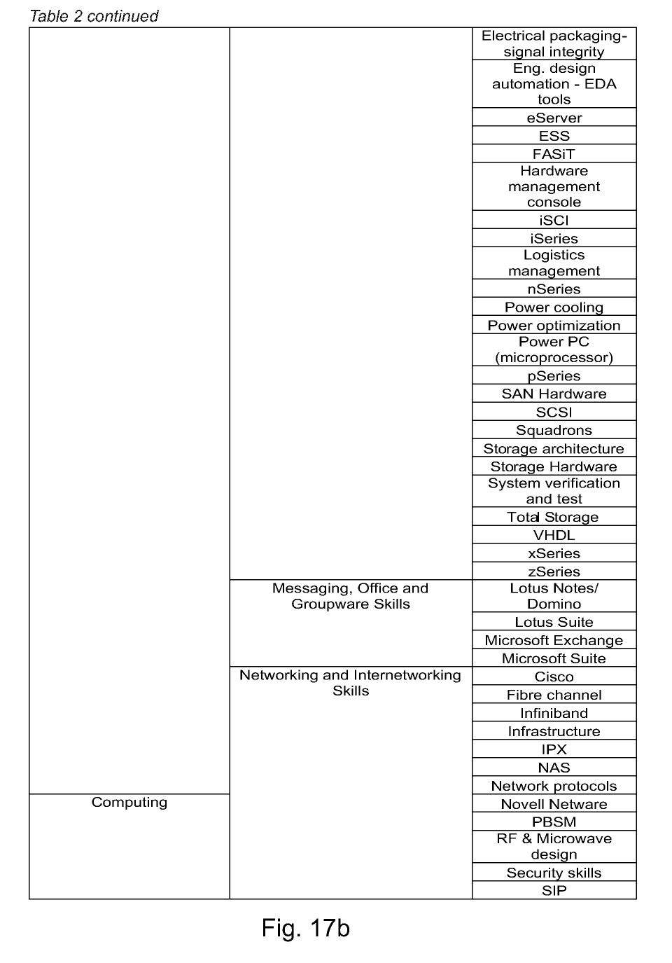

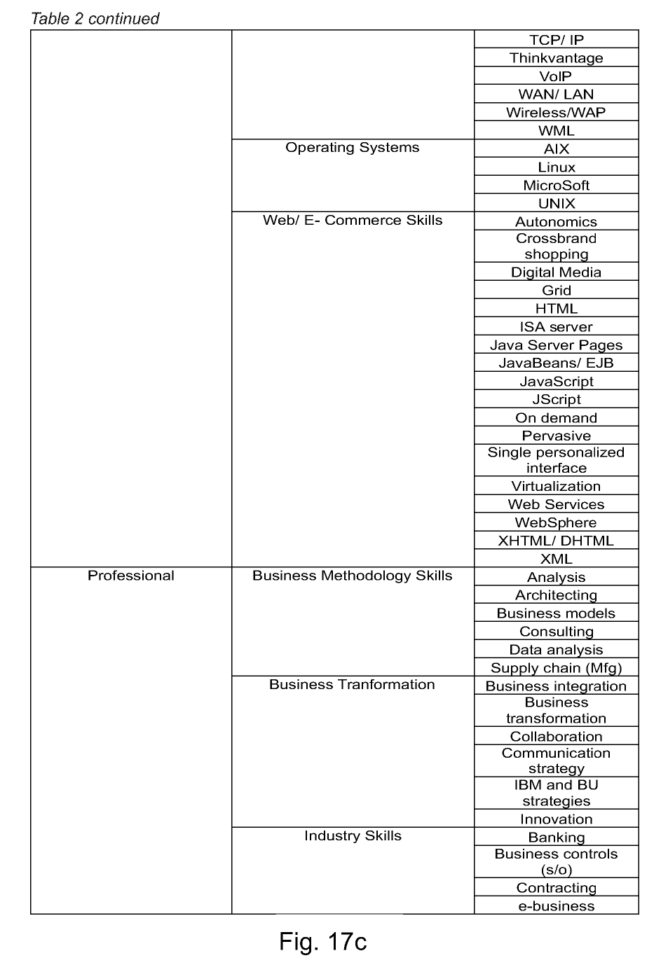

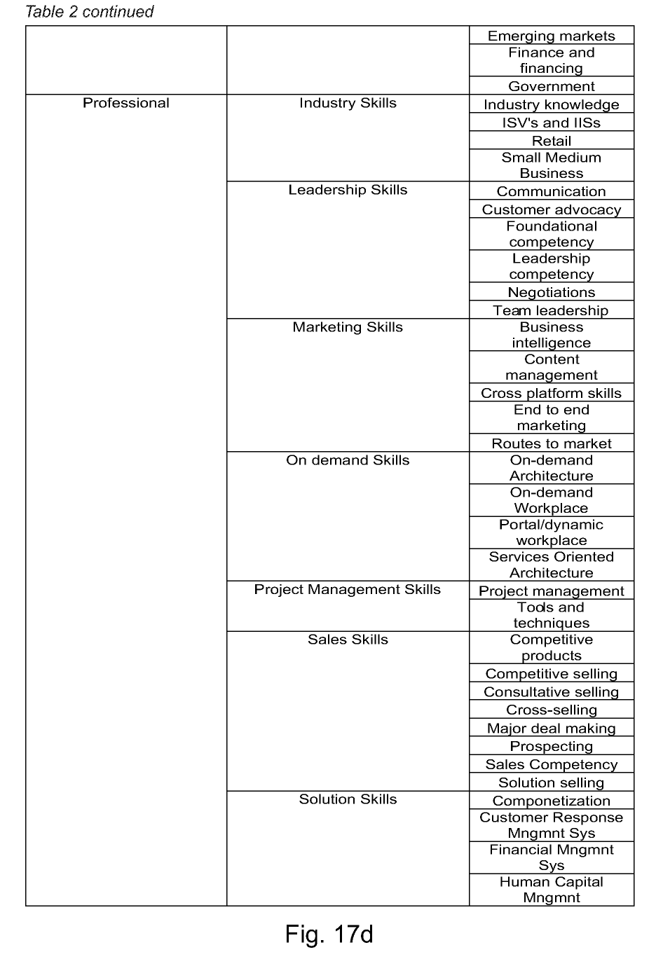

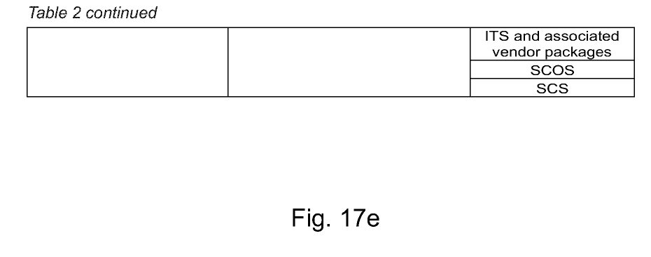

The structuring of learning requires a hierarchical taxonomy in order to categorize the parameter data. Referring now to Table 1 (FIGS. 16a-16e) and Table 2 FIGS. 17a-17e), two examples of possible taxonomies are competency based Table 1, and market valued skills based Table 2. The two taxonomies listed are exemplary only and other taxonomies applied to the disclosed embodiments of the present invention.

In a competency based taxonomy a data structure based upon competency type, for example ‘Hardware Defect Training’, competency area, for example ‘Integrated Technology Services’ and skill area, for example‘Maintenance: S390’. The methodology uses this hierarchical taxonomy in the recording of learning data and the definition of learning solutions.

In a market skill based taxonomy uses a similar approach to that in the competency based taxonomy but it is the market value of the skill learnt that determines the its inclusion in the taxonomy to categorize competency and skill areas.

The particular taxonomy used is dependent upon the business or organisation employing a learning planning solution in accordance with the embodiments of the present invention. Indeed, a hybrid taxonomy encapsulating categorizations of data according to aspects of any number of taxonomies is envisaged.

Typically, the users of embodiments of the method of resource planning will be employees of a medium to large business, for example a business employing more than a few hundred people. An illustrative user of an embodiment of the method of resource planning will employ from five hundred employees based in five or more locations, and require twenty or more competencies to be considered. It will be appreciated that the an organisation of any size may use an embodiment of the method of resource planning.

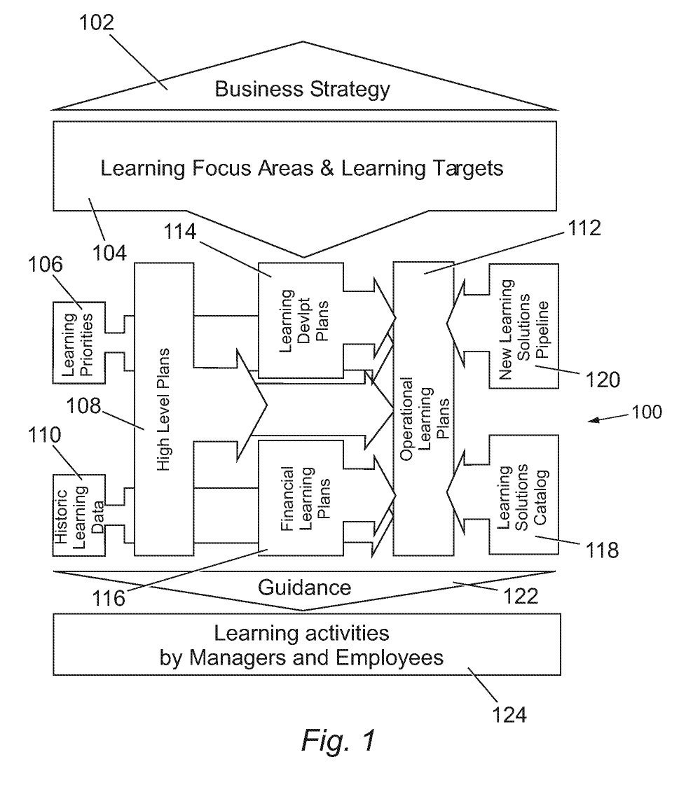

FIG. 1 shows the structure of the overall learning plan 100 in which the overall business strategy 102 leads to a focus upon particular learning areas and targets 104 that determine the business' learning priorities 106. These learning priorities 106 feed into the generation of both high level plans (HLP) 108 for training along with historic learning data 110. The historic learning data 110 typically details the training undertaken in the previous twelve months training on a business unit level. The HLPs 108 give details of the training required at each business level to help attain the targets 104 defined by the business strategy 102.

The HLPs 108 output data into operational learning plans (OLP) 112 along with learning development plans 114 and financial learning plans 116. The OLP 112 assesses the training needs of a business unit, and hence constitute micro learning plans. The OLP is constructed in light of the data received from the HLP 108, the historic learning data 110, the learning priorities 106 and the learning development and financial learning plans 114, 116. The OLPs 112 then allocates the most appropriate training course from a learning solutions catalogue 118, with reference to new learning solutions currently under development 120.

The result of this methodology is guidance 122 on learning priorities and their associated training activities 124 provided to managers and employees of the business tailored to the business strategy underpinning the business as a whole.

Typically, the learning planning process is typically executed once one year in advance to generate the learning plans (SLP, HLP, OLP, FLP, LDP) for any given year. There exists the possibility to run update cycles once or twice during the given year to account for changes in learning priorities, headcount and business priorities.

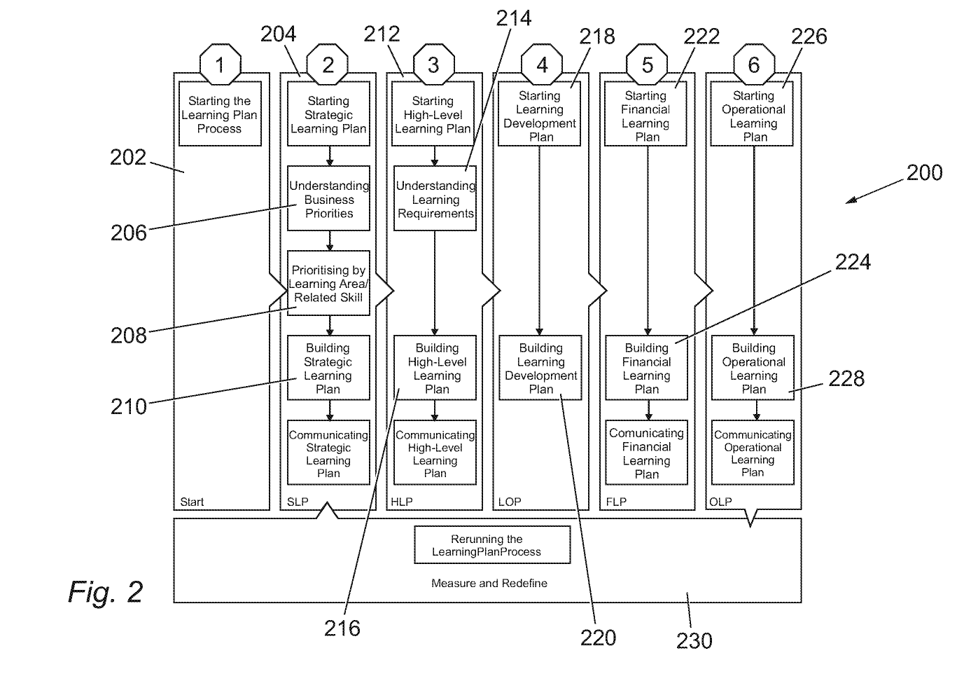

FIG. 2 shows the six phases of an embodiment of a learning plan methodology, the initial phase is the start of the learning process 202, this involves the realisation that training is required and putting in place the mechanisms for learning to occur, for example web-sites for eLearning and classroom facilities.

The second phase is the strategic learning plan (SLP) 204. This comprises the identification and understanding of business priorities 206, for example increased growth in EMEA region, or consolidation of US operations. Each learning area or skill is then prioritized 208 with reference to the identified business priorities 206. The business develops and builds a strategic learning plan 210 focussing on those areas of training identified and prioritized as core to the development of the business. Dissemination of the strategic learning plan 204 throughout the business units facilitates understanding of how the business priorities 206 are achieved through training.

This plan brings together the business objectives and priorities and focuses the training plan on them.

The initial phase of developing the strategic learning plan involves starting of the process and identifying target representatives, typically from a business' board, executives or managers of the business' business unit managers. These representatives will typically have knowledge of the objectives of the business and developments that may affect the direction of the business in the short, less than six months, medium six to eighteen months, or long term, more than eighteen months.

The next phase of the SLP development is the determination of delivery targets and definition of the learning focus areas. Typically, this involves prioritising the business objectives. Typically, a meeting of the representatives, a questionnaire sent out business unit managers and executives within the business, is used to document the business objectives and learning focus areas. Training targets, such as the number of course days available for a business unit and the available budget for the training, are set with reference to the business requirements.

A check ascertains that the areas upon which training focuses are the correct areas in view of the business objectives.

The third phase is the generation of the HLP 212. This requires the understanding of learning requirements 214 to affect the training required to meet the business priorities 206. From the understanding of the learning requirements 214 and input data referred to in relation to FIG. 1 the methodology builds the HLP 216. The HLP 216 disseminates throughout the business units via a computer network.

The next period's is learning requirements use the previous period's learning requirements as a template. An input from human resources or resource management authority deals with the effects of the training, for example promotion or redundancy of employees, due to increased training of either employees or their co-workers.

A detailed description of an embodiment of a method of HLP generation is detailed hereinafter.

The fourth phase is learning development plan 218. The learning development plan 220 occurs with reference to the requirements of the business priorities 206 and the available resources and new resources that are under development.

Typically, a learning development plan reflects the learning requirements currently not fulfilled by any existing learning activities/courses in the catalogue. For example, the need to develop skills in an emerging technology might result in a line in the learning development plan in order to have new course material developed.

The learning development plan 218 involves identifying target representatives who may input their knowledge into the learning plan. These people may be human resources experts, business unit managers, executives or specialist trainers. The plan is built using the input of the representatives. The business rejects certain learning development requirements when the plan is offered for global acceptance within the business. Certain of the learning development plan requirements may be rejected subsequently when the globally accepted plan is sent for local, regional, approval at business units. This may be because of the incompatibility of the plan with cultural or language requirements in a locale.

Other possible grounds for the rejection of elements of a learning development plan may include that an employee applying for the training works in a business unit or geographical location where a number of people have received the requested training. Conversely, the attendance of a number of employees from a business unit addresses a particular skill shortage identified in the business unit. This results in business priorities being addressed either within the context of a particular geographical business unit, or within the context of the business as a whole, as appropriate.

For example, if a business unit undertakes a number of projects prior training in project management is appropriate for a number of employees within that business unit.

Other parameters taken into consideration in making a determination of the suitability of training can include the affordability of the training, within either a specific business unit, or the business as a whole.

The fifth phase is financial learning plan 222. The building 224 of the financial learning plan takes into account financial constraints such as, for example, the effect upon a business unit of employee's absence for training, the cost of preparing course material, resource usage such as bandwidth usage or terminal time.

The financial learning plan receives inputs from the learning development plan 218, the HLP 212 and direct input from business units and lines of business (LoB) to determine the financial implications of the training.

The sixth phase is the generation of an OLP 226. This uses data received from the earlier phases of the methodology to build a business level learning plan 228 that determines the most appropriate courses and locations for an employee to attend a training course and the division of classroom based and eLearning courses. The OLP 228 disseminates throughout the business units. A detailed description of a preferred embodiment of a method of OLP generation is detailed hereinafter.

Data output from the generation of the OLP feeds back into the strategic learning plan in order to improve the accuracy and alignment of finally generated OLPs with the business objectives and priorities 230.

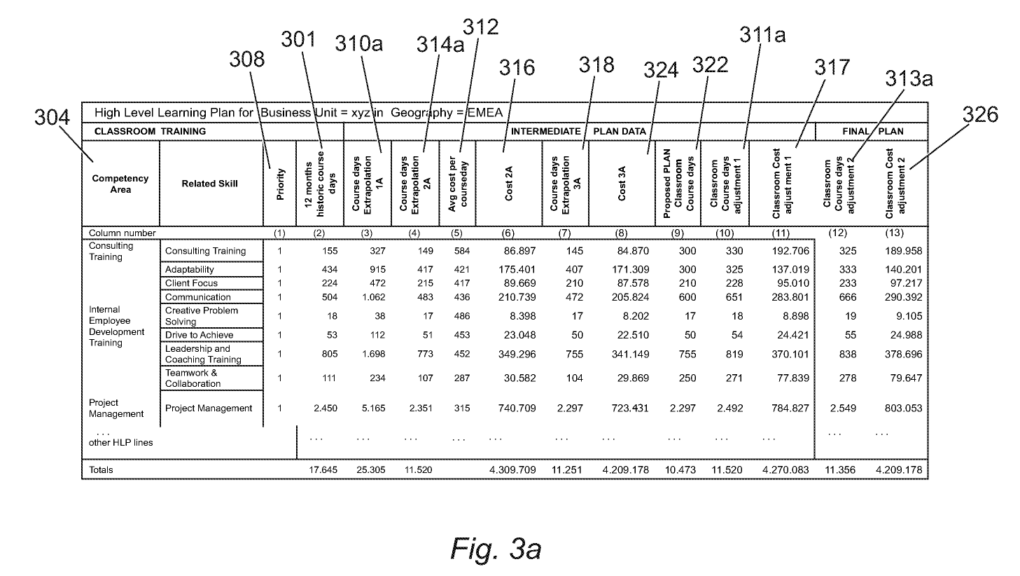

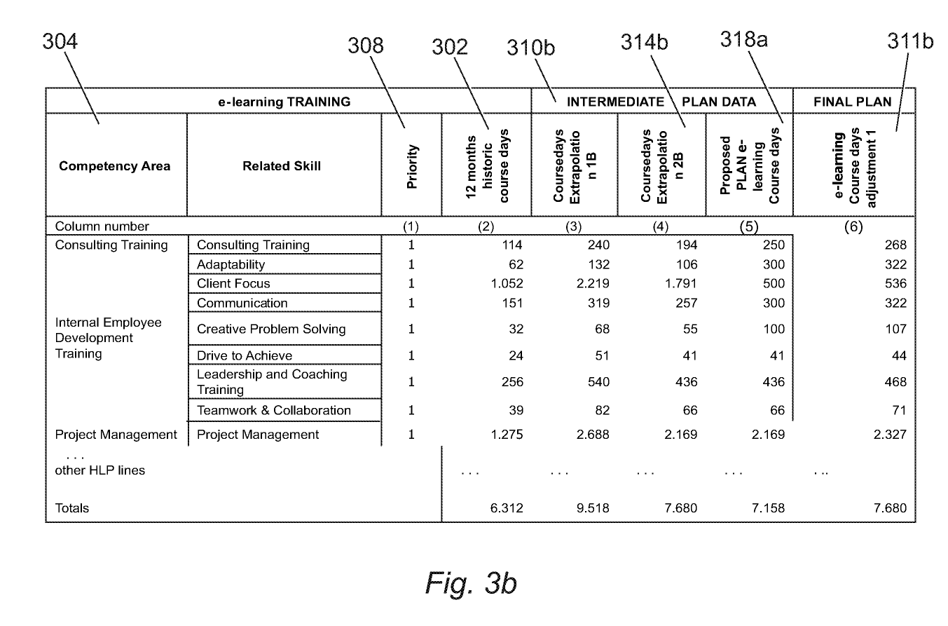

FIGS. 3a and 3b depict spreadsheets detailing the various parameter, stages and adjustments used in assessing a business unit's initial training request plans according to an embodiment of a method according to the present invention. In the example shown in FIG. 3a a year on year headcount of 105% occurs and targets have been set of: (i) number of classroom course days 11,520 (Target A); (ii) overall classroom delivery cost 4,209,178 (Target C); and FIG. 3b (iii) number of eLearning course days 7.680 (Target B).

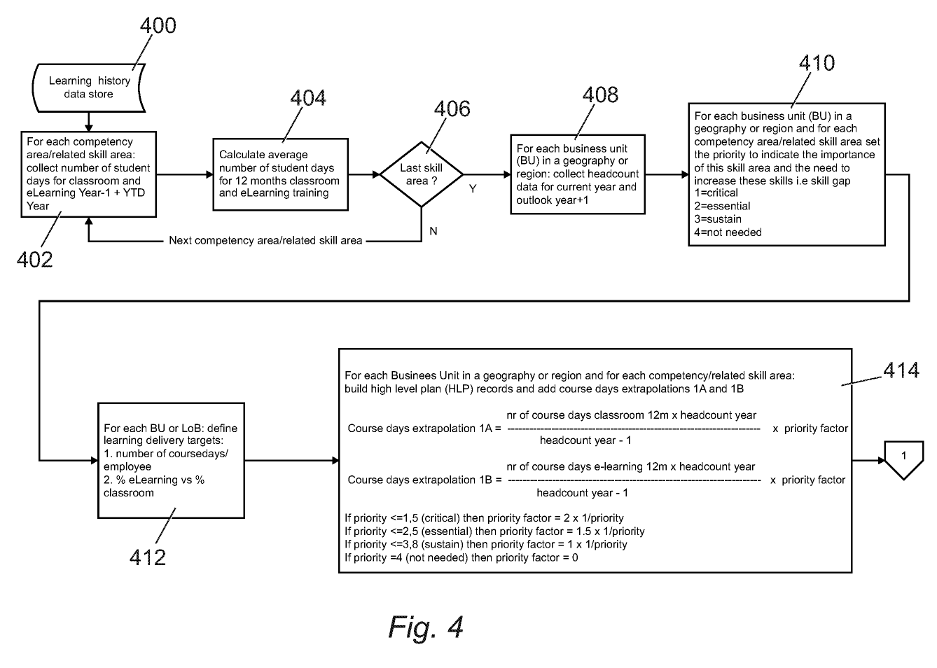

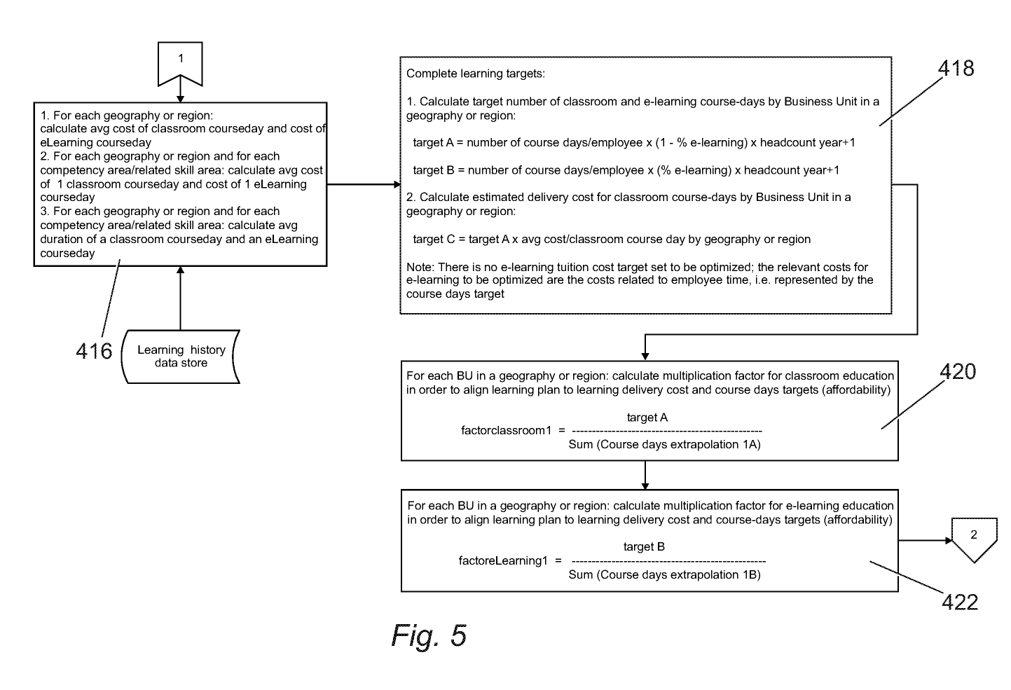

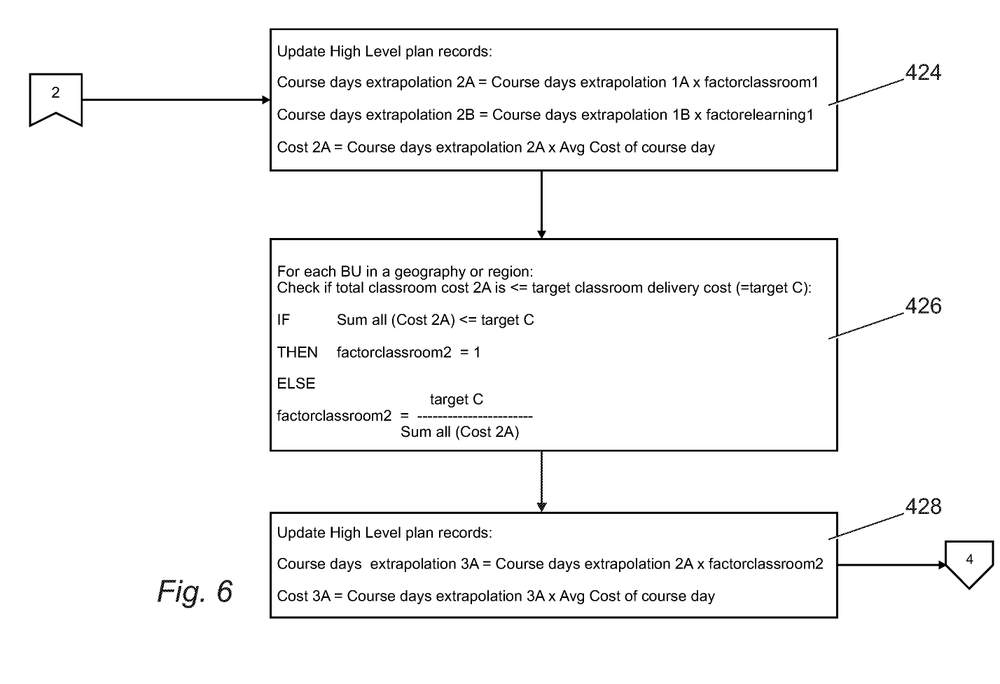

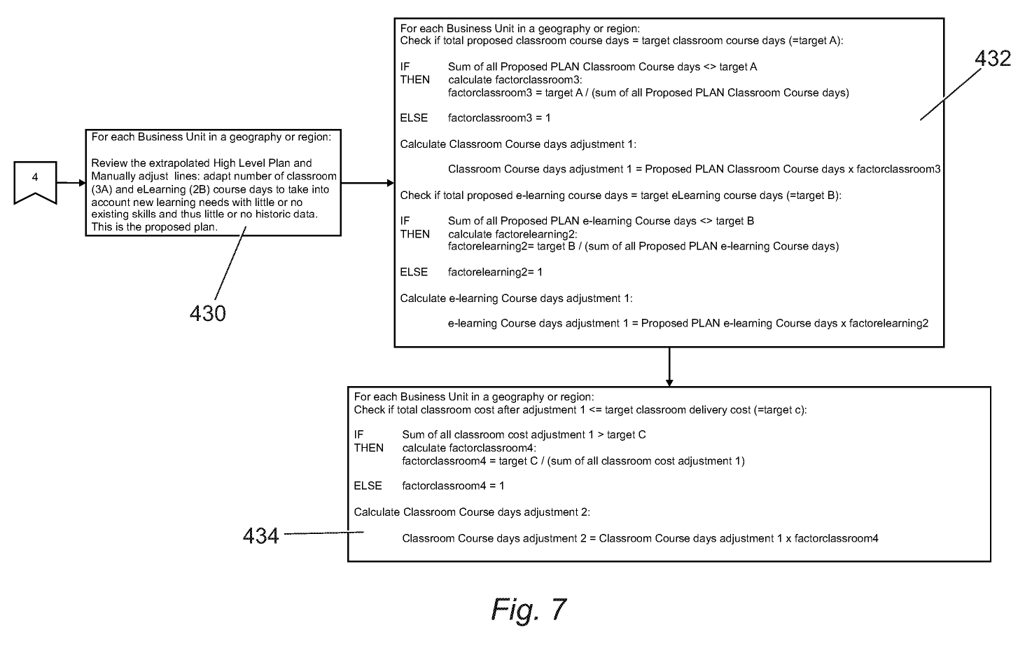

FIGS. 4 to 8 disclose an embodiment of a method of generating a high level learning plan employing a competency data based taxonomy. Generally, this method is applicable to other taxonomies of data.

An assessment of historical training data (Step 400) collects the number of classroom 301 and electronic 302 (eLearning) course days spent on training over the last year in each of a number of competencies 304 (Step 402).

The historic data collected for a period over 12 months is averaged over a twelve month period (Step 404).

A collection of headcount data of a business unit on a geographical or regional basis for the next year takes place (Step 408).

The generation of priority factor data 308 in each competency area 304 occurs, generally with reference to skills lacking from a business unit (Step 410). Typically, the prioritization of skill areas takes the form of the assignment of a ranking value to each skill area. In the present embodiment, the ranking values are between one and four although any number of ranking values may be used as appropriate to the needs of the business.

Targets for each business unit or lines of business (LoB) such as the number of course days for each competency 304 within the business unit and the ratio of eLearning to classroom based learning are defined (Step 412). Typically, the number of course days for each employee is defined uniformly across a business unit, by geographic region.

The method estimates the number of course days required for the business unit (Step 414), the first course days extrapolation 310a,b. The calculation of first course days extrapolation is for both classroom 310a and eLearning 310b training.

The determination of the first course days extrapolation 310a involves the multiplication of the number of classroom based course days undertaken in the past year 301 by the increase in headcount and the priority factor 308 assigned to each competency 304.

A cost analysis of classroom and course days is made, as are the estimated duration of both classroom and eLearning course days (Step 416). In the present embodiment the average costs of both classroom days are estimated for each geographical region. Factors accounted for in the costs of course days include trainer's travel costs, trainers utilization cost, classroom delivery costs, course material costs, back-office application costs. A similar analysis is conducted with reference to each competency 304. The analyses use data retrieved from the learning history data structure.

The central processor calculates learning targets (Step 418) for each business unit in a geographical area. These targets include the projected number of classroom course days for each competency 304 for the coming year and the estimated delivery cost of classroom based training (Target B).

The estimation of the number of classroom 311a and eLearning 311b training days comprises multiplying the total first course days extrapolation 310a,b by the respective percentage of either classroom or eLearning by the headcount for the coming year.

The calculation of the estimated delivery cost of the classroom based training comprises multiplying the estimated number of classroom based training days 311a by the average cost of a classroom based course day 312 in a given geographical area or region for that competency.

eLearning is assumed to have a minimal, or zero, cost. Whilst this is generally the case the cost of setting up of eLearning courses for example; tutors time in setting the course and databases can be accounted for in a similar manner to that of classroom based training.

An alignment of the training plan delivery cost (Target C) and the course day targets (Targets A and B) requires the calculation of respective adjustment, weighting, factor 313a for the classroom and eLearning elements of the training (Steps 434).

The calculation of the classroom adjustment factor 313a involves the division of the respective target classroom cost (Target C) by the estimated total cost of the plan.

The performance of a similar calculation for the eLearning course days generates an eLearning adjustment factor 311b.

Updating of higher level training plan data records occurs (Step 424). Typically, this involves multiplying estimated number of classroom course days 310a by the weighting factor to generate a second revised classroom course day extrapolation 314a. A similar calculation for the estimates number of eLearning course days 311b yields a second revised eLearning course day extrapolation 314b.

Calculation of a second, revised, cost 316 of the training involves multiplying the second classroom course days extrapolation 314a by the average cost of a classroom course day 312.

A cost analysis of the classroom training occurs (Step 426). This involves determining if the total cost 316 of the proposed training is within the pre-determined delivery cost Target C.

If the revised delivery cost target value 316 are within target delivery cost C a revised classroom weighting factor is unity. If the revised delivery cost target value 316 are not within target delivery cost C the revised classroom weighting factor 317 is the delivery cost target value C divided by the sum of the revised costs of the training 316.

An update of higher level training plan data records occurs (Step 428). This involves the determination of third, further revised, classroom course days extrapolation 318 and cost of training 324 taking into account the revised classroom weighting factor.

Should the cost of eLearning be incorporated into the method then this analysis can be made for eLearning also.

A supervisor accesses the higher level training plan data records and adjusts the entries manually in response to additional training requirements (Step 430). These additional training requirements may be due to a business initiative or due to specific requests of an employee, or employees. This improves the quality of training received by employees as additional training requirements typically will not have entries in the historic training database.

Checks of the whether the number of classroom 322 and eLearning course days comprising the third course days extrapolation are compatible with the respective targets (Targets A, B) are made (Step 432). If number of proposed days differs from the respective target numbers of days (A, B) further revised weighting factors are generated, and adjustments made accordingly using the weighting factors 317.

A final cost analysis check occurs (Step 434). This is similar to the check described earlier in that a reduction in the number of classroom course days 322 occurs if the overall cost exceeds the target classroom delivery cost (C).

Below is an example of the calculations involved in the formation of a HLP in accordance with an embodiment of the present invention.

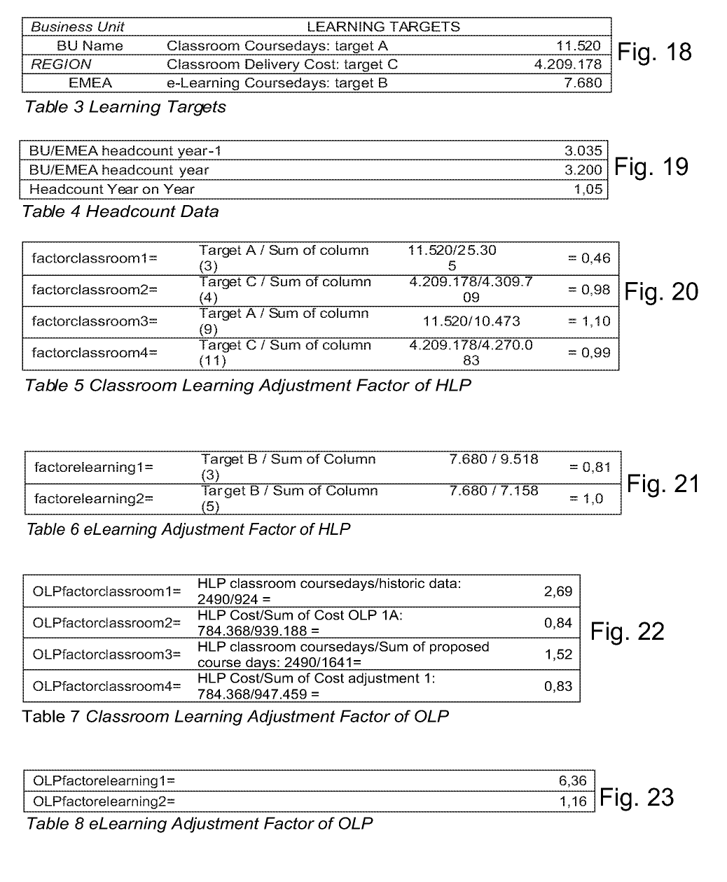

Table 3 (FIG. 18) and Table 4 (FIG. 19) detail learning targets and headcount figures used in the example of the calculations involved in the formation of the HLP. Table 5 (FIG. 20) details the calculation of values of classroom learning adjustment factors used in the example of the calculations involved in the formation of the HLP, with reference to Tables 3 and 4 and FIG. 3a.

In relation to classroom training, in FIG. 3a:

Columns 1, 2 and 5=input data from historic data store.

Column 3=Column 2×priority factor×Year on Year headcount

Column 4=Column 3×factorclassroom1

Column 6=Column 4×Column 5

Column 7=Column 4×factorclassroom2

Column 8=Column 7×Column 5

Column 9=Column 7+manual adjustment to include new initiatives

Column 10=Column 9×factorclassroom3

Column 11=Column 10×Column 5

Column 12=Column 10×factorclassroom4

Column 13=Column 12×Column 5

Table 6 (FIG. 21) details the calculation of values of eLearning learning adjustment factors used in the example of the calculations involved in the formation of the HLP, with reference to Tables 3 and 4 and FIG. 3b.

In relation to eLearning, in FIG. 3b:

Columns 1 and 2=input data from historic data store.

Column 3=Column 2×priority factor×year on year headcount

Column 4=Column 3×factorelearning1

Column 5=Column 4+manual adjustment to include new initiatives

Column 6=Column 5×factorelearning2

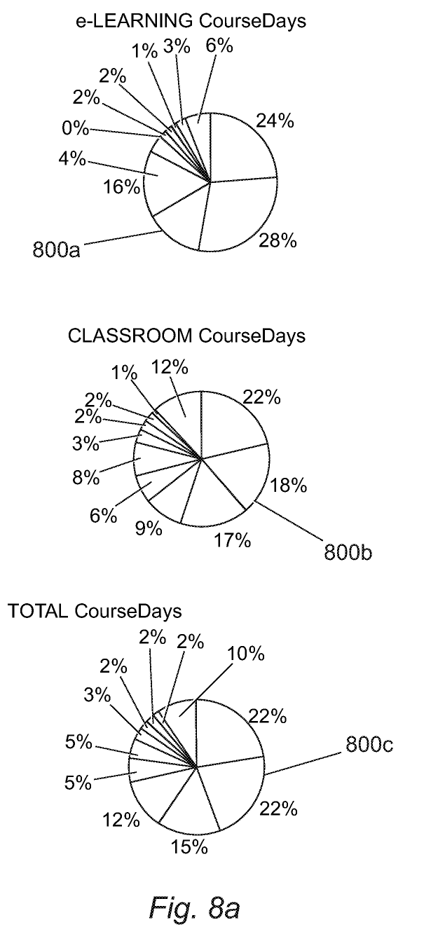

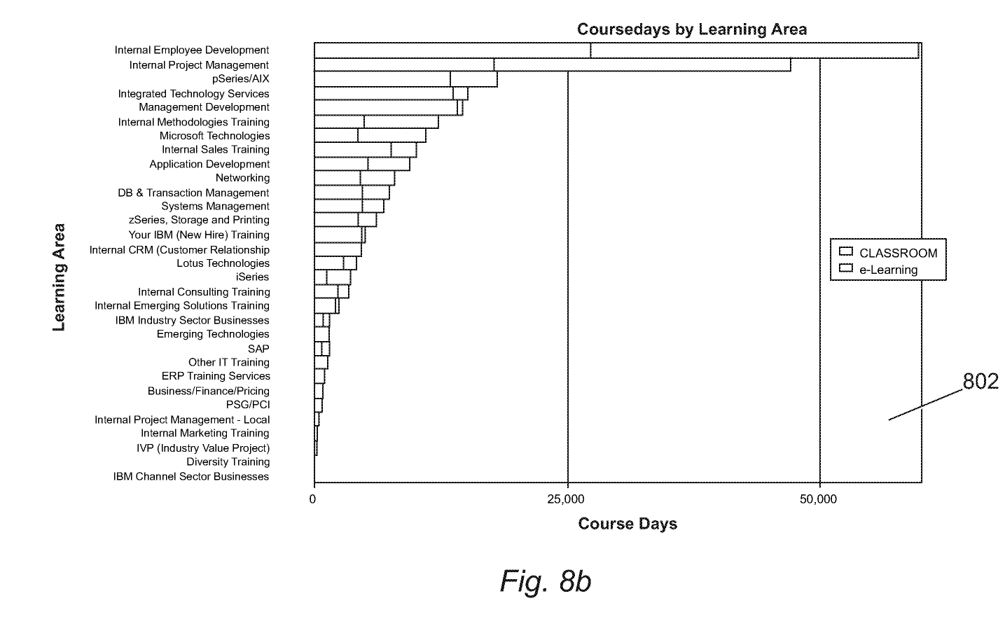

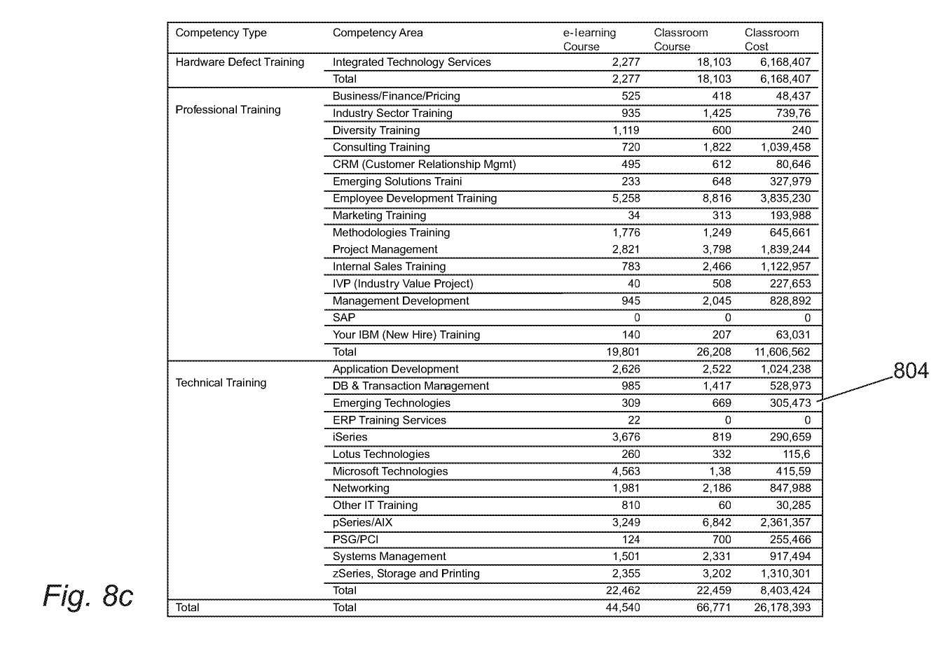

Referring now to FIGS. 8a to 8c, the higher level learning plan contains the breakdown of a proposed training plan for a business unit or geographical area by competency area. A number of ways of displaying this breakdown of the proposed training plan include a pie chart 800, a bar graph 802 or a table 804. The breakdown of the proposed training plan can be further sub-divided into classroom based training 800a,b or as respective bar graphs or tables.

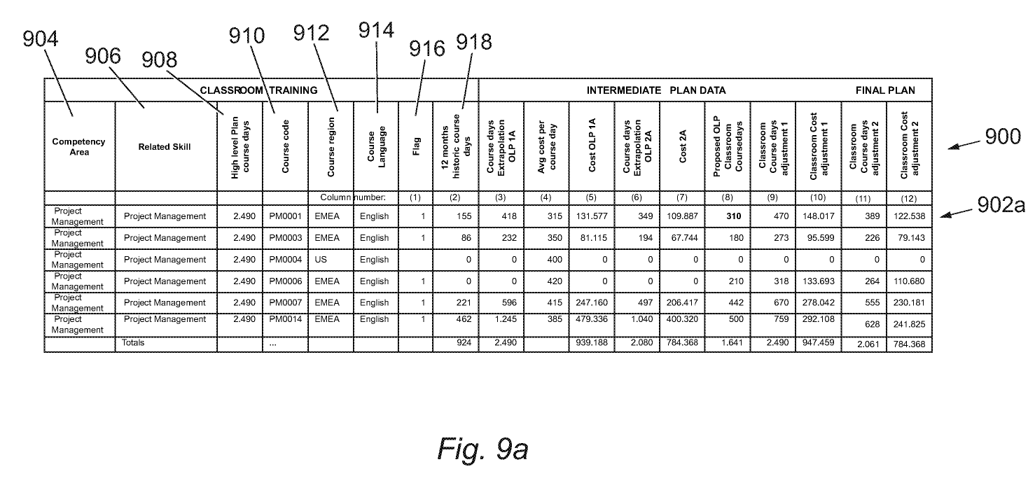

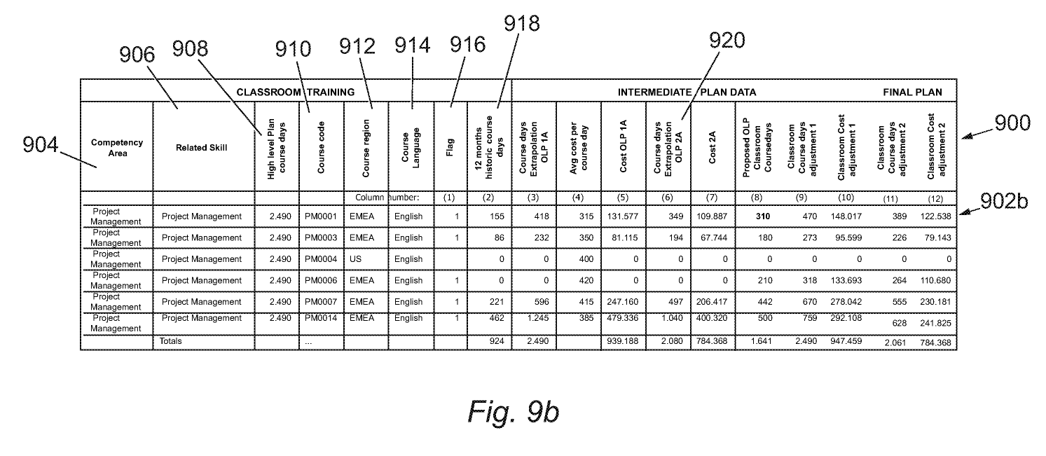

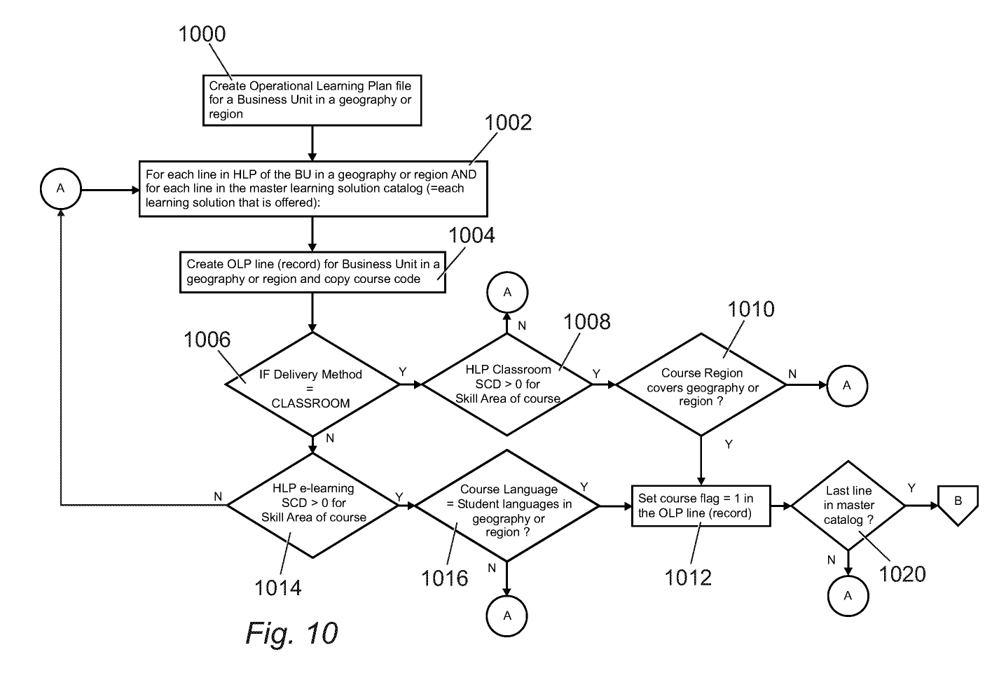

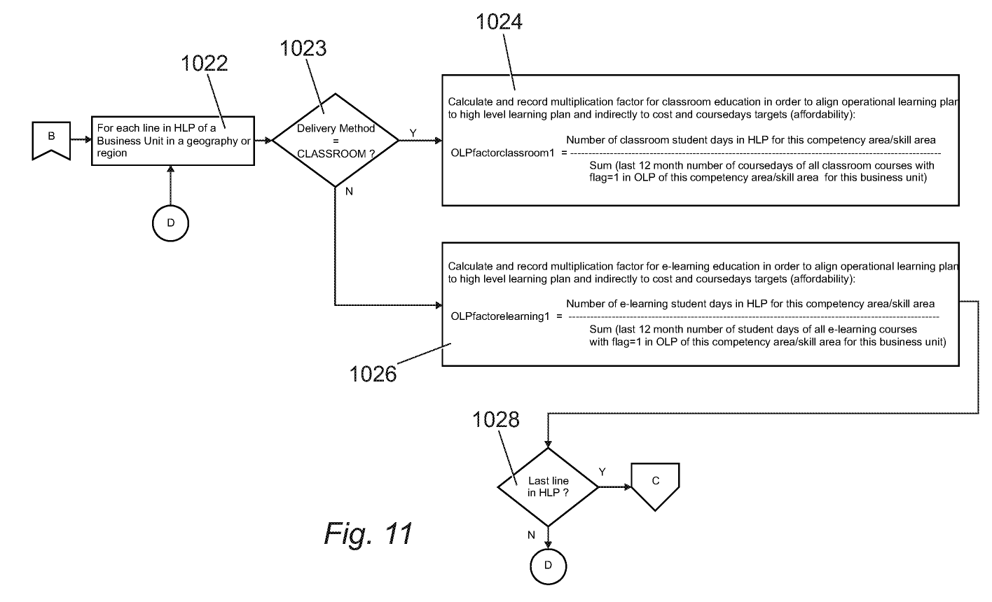

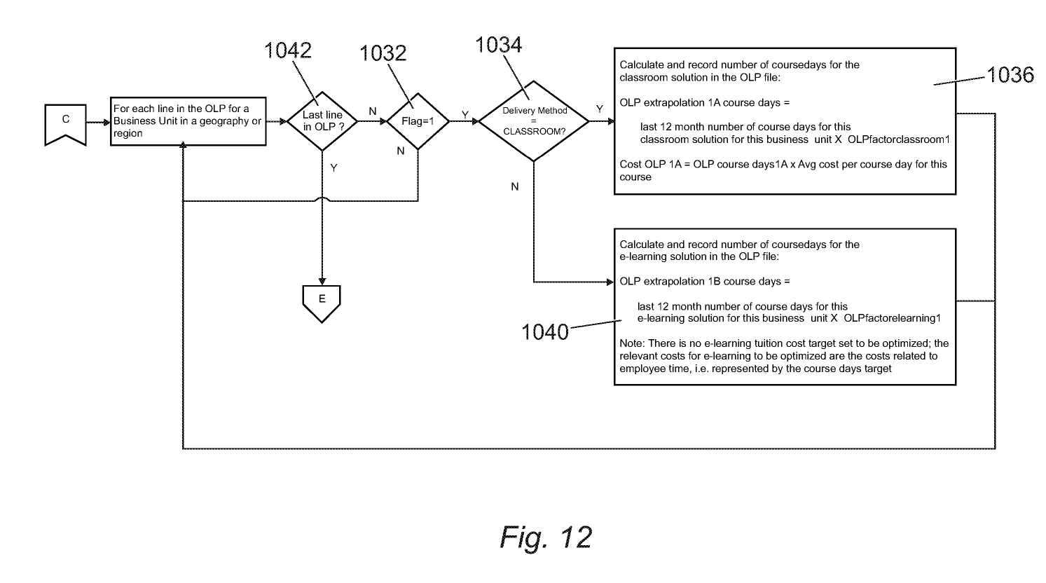

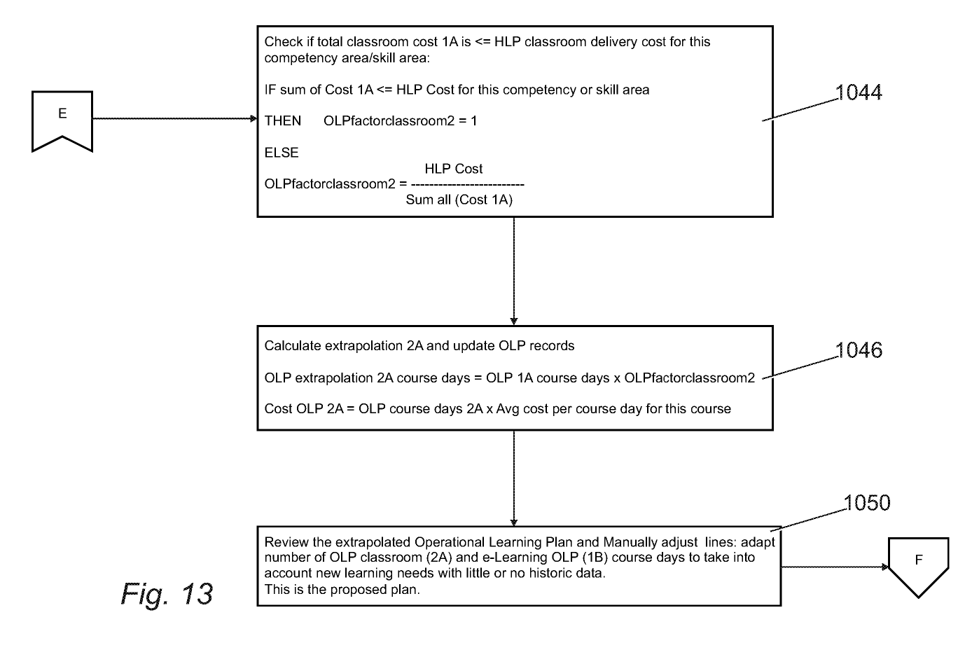

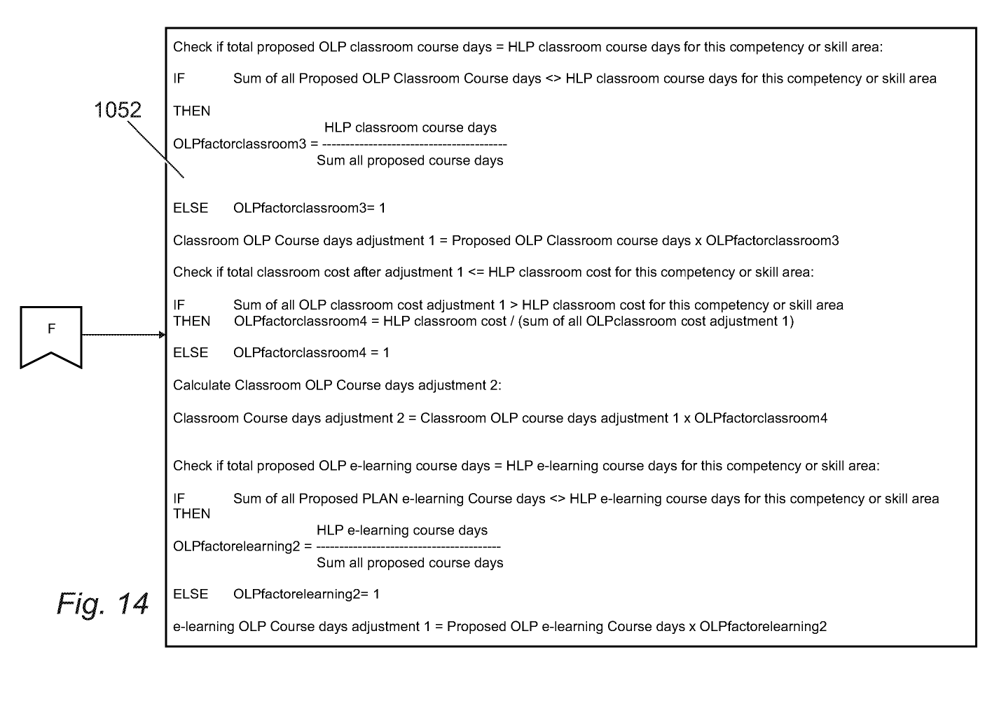

Referring now to FIGS. 9 to 14, an operational learning plan (OLP) 900 draws upon data generated in the higher level learning plan, historic learning data, and a database of learning solutions to provide detailed guidance to employees at a business unit level and to improve the quality of learning delivery. An ideal OLP facilitates the selection of learning solutions and optimises the learning delivery throughout a business unit or geography in view of the priorities of the business unit and budgetary constraints.

An embodiment of an OLP 900, for example relating to “Project Management”, comprises two components; a classroom based training component 902a and an eLearning component 902b. Each of the components 902a,b have several common data fields: competency area 904, related skill 906, HLP course days 908, course code 910, course region 912, course language 914, flag 916 and historic course attendance 918.

The number of entries in the data fields of the two components 902a,b will not necessarily be the same as the number of classroom courses and eLearning courses available for any given competency may not be the same. The competency area 904 and related skill 906 data fields relate to the area in which training is sought. The HLP course days 908 data field details the number of course days allocated to each competency in the HLP, this may or may not be the same in each of the classroom and eLearning components 902a,b, typically these values will differ.

The course code 910 data field give an identification code associated with each course listed in the components 902a,b. The course region 912 data field details the geographical region in which the course is taking place. The flag 914 data field relates whether a specific training course is available to a business unit and the historic course attendance 918 data field details the number of classroom or eLearning training days attendance at each course the business unit members have made over the previous twelve months.

In the case of the eLearning component 902b of the OLP 900 a first eLearning course days extrapolation 920 is determined by multiplying the number of historic learning days for any given course held in data field 918 by an OLP eLearning factor. The OLP eLearning factor is determined according to a methodology described hereinafter.

In the first stage of OLP generation a central processor generates an OLP file for a business unit, typically for a business unit in a particular geography or region (Step 1000). Each competency in an HLP has a corresponding set of possible learning solutions from a master learning solution file associated with it (Step 1002). The course codes and details, such a locale, language, for each competency are copied from the master learning solution file to the OLP file (Step 1004). Each course solution is assessed to determine if it is classroom based or eLearning based (Step 1006).

If the course is classroom based the skill area of the course is assessed to see if a demand for training exists in the skills area, if not the next course solution is analysed (Step 1008). If a demand for the skill area exists in the HLP the system checks the geographical suitability of the course venue for the business unit, if not next course solution is analysed (Step 1010). If the classroom based course is geographically suitable for the business unit the course flag data filed is set to ‘1’ to indicate that the course solution is available for use by the business unit (Step 1012).

Similarly, if the course is eLearning based the skill area of the course is assessed to see if a demand for training exists in the skills area, if not the next course solution is analysed (Step 1014). If a demand for the skill area exists in the HLP the system checks the suitability of the eLearning based course for employees within the business unit (Step 1016), for example is the language compatible, if not next course solution is analysed. If the eLearning based course is suitable for the business unit's employees the course flag data filed is set to ‘1’ to indicate that the course solution is available for use by the business unit (Step 1012).

If the course solution assessed is not the last line in the master learning solution file the next course solution is analysed (Step 1020).

The second stage of OLP generation involves an assessment of each competency in the HLP for a given business unit as to whether the delivery method of the proposed training is classroom based or eLearning based (Step 1023).

If the training is classroom based the calculation of an OLP adjustment factor for classroom based courses by dividing the number of HLP classroom course days the sum of the last twelve months number of student days of all eLearning courses with flag=1 in the OLP for this competency area/skill area for this business unit (Step 1024).

An OLP adjustment factor for eLearning based courses is calculated is a similar manner (Step 1026).

If the course solution assessed is not the last competency or skill in the HLP then adjustment factors are calculated for the next competency or skill (Step 1028).

The third stage of OLP generation involves the calculation of the number of course days in the OLP. A check to determine if the entry in the OLP under assessment is the last entry in the OLP occurs (1024). If the OLP entry under assessment is not the last an assessment of whether the training course is available to the business unit occurs (Step 1032), for example is the flag data field set to‘1’? If the training course is not available to the business unit the next training course is assessed.

If the training course is available to the business unit a determination of whether the training course is classroom or eLearning based occurs (Step 1034). Should the training course be classroom based an OLP extrapolation of classroom course days is calculated by multiplying historical number of course days used by the business unit for the classroom training solution by the OLP adjustment factor for classroom based training course previously calculated (Step 1036). This OLP extrapolation of classroom course days feeds into a calculation of the cost of the classroom training course where it is multiplied by the average cost per day of the training course solution.

A similar calculation of an OLP extrapolation of an eLearning based training course occurs should the earlier determination be that the course is indeed eLearning based (Step 1040). No cost calculation is envisaged for eLearning based training course in the present embodiment as they are assumed to have zero cost. However, as noted hereinbefore with reference to the HLP costing may take place to account for the cost of course tutors time, web designer's time and other factors such as the use of bandwidth.

If the determination is made that the entry in the OLP under assessment is the last entry in the OLP then the OLP generation enters the next stage (Step 1042).

In the preferred embodiment, the fourth generation stage of the OLP comprises the alignment of course day requirements and budgetary constraints between the OLP and the HLP.

If the total cost of a classroom training course does not exceed the delivery cost target (C) for the competency or skill area under assessment of the HLP for the competency or skill area under assessment then a cost adjustment factor is set to unity. However, if the total cost of a classroom training course exceeds the delivery cost target (C) of the HLP then the cost adjustment factor set to be equal to the delivery cost target (C) divided by the sum of the costs of the training course (Step 1044).

Refinement of the OLP extrapolation of classroom course days comprises the generation of a revised OLP extrapolation of classroom course days (Step 1046). This involves the multiplication of OLP extrapolation of classroom course days by the cost adjustment factor.

A manual review of the interim OLP occurs involving the adjustment of course day numbers, both classroom and eLearning based, in response to learning needs having no, or little, historical data associated with them (Step 1050).

The fifth stage in the OLP generation comprises an adjustment of the OLP into alignment with the HLP. This involves the final scaling of both cost and course days, both classroom based and eLearning determined in the OLP into alignment with the targets (A)(B)(C) determined into the HLP. Scaling factors are again calculated in the manner described hereinbefore and applied to the number of course days and cost, if appropriate (Step 1052).

Below is an example of the calculations involved in the generation of an OLP in accordance with an embodiment of the present invention.

Table 7 (FIG. 22) details the calculation of values of classroom learning adjustment factors used in the example of the calculations involved in the formation of the OLP, with reference to Tables 3 and 4 and FIG. 9a.

In relation to classroom based training, in FIG. 9a:

Columns 1,2 and 4=input data from first step of OLP algorithm from historic data store

Column 3=Column 1×OLPfactorclassroom1

Column 5=Column 3×Column 4

Column 6=Column 3×OLPfactorclassroom2

Column 7=Column 4×Column 6

Column 8=Column 6+manual adjustment to include new initiatives

Column 9=Column 8×OLPfactorclassroom3

Column 10=Column 4×Column 9

Column 11=Column 9×OLPfactorclassroom4

Column 12=Column 4×Column 11

Table 8 (FIG. 23) details the calculation of values of eLearning adjustment factors used in the example of the calculations involved in the formation of the OLP, with reference to Tables 3 and 4 and FIG. 9b.

In relation to eLearning training, in FIG. 9b:

Columns 1,2 and 4=input data from first step of OLP algorithm from historic data store

Column 3=Column 1×OLPfactorelearning1

Column 5=Column 3×Column 4

Column 6=Column 3×OLPfactorelearning2

Column 7=Column 4×Column 6

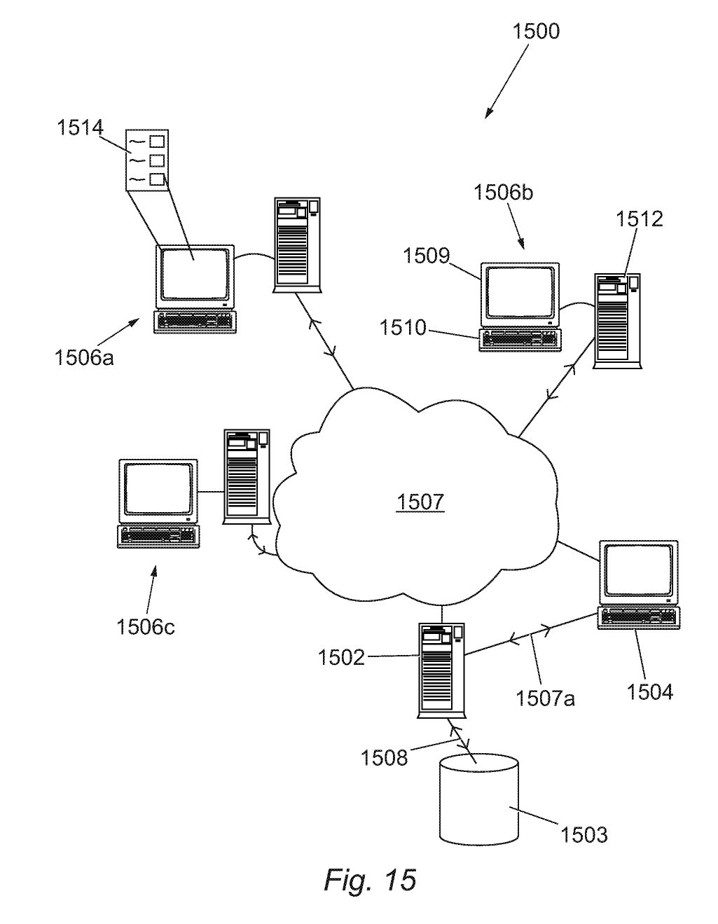

Referring now to FIG. 15, an embodiment of a resource allocation system 1500 comprises a server 1502, data repository 1503, an admin workstation 1504, a number of user terminals 1506a-c and a network 1507.

In the present embodiment, the server 1502 is a back office mainframe system that is dedicated to learning management operations. The server 1502 generates reports in Brio, or any other suitable data format, that feed to the admin workstation 1504. The server 1502 connects to the workstation 1504 either via the network 1507 or via a dedicated connection 1507a.

The data repository 1503 is a IBM DataBase 2 Enterprise On Windows 2000 server. The data repository stores the historic training data structure, and data structures corresponding to each of the phases of the learning plan methodology embodied in FIGS. 1 to 14, for example OLP and HLP. The data repository 1503 communicates with the workstation 1504 via a local area network (LAN) 1508, and usually employs the Open Database Connectivity™ (ODBC) for data transfer, or any other suitable data transfer protocol.

In an embodiment the terminals 1506a-c are personal computers (PCs) each having a screen 1509, a keyboard 1510 and a processor unit 1512. Typically, the terminals 1506a-c are PCs employing Intel Pentium 4 processors.

Typically, the network 1507 is the Internet, or an intra-net, and facilitates communication between the workstation 1504 and the terminals 1506a-c.

Users of the system 1500 enter requests for training into appropriate data entry fields a GUI 1514 displayed on the screen 1509 using the keyboard 1510. In a preferred embodiment, the GUI will be a MS-Excel™ spreadsheet, although other proprietary or bespoke GUI's may be used. Data entry fields may include “name of applicant”, “business unit”, “training requested” and “applicant location”.

The terminals 1506a-c pass the requests are to the workstation 1504 over the network 1507.

The workstation 1504 executes the methodology described hereinbefore in relation to the generation of a learning plan for a business unit based upon data entered by the users and upon the data stored within the data repository 1503.

The workstation 1504 notifies each user of the acceptance or refusal of a request for training at their terminal 1504a-c via the network 1507, typically in the form of an MS-Excel™ spreadsheet, a Brio report. It is envisaged that in at least some embodiments of the invention the OLP may be displayed via a portlet on the World Wide Web, Lotus Notes, or Domino.

What is claimed is:

1. A method of resource allocation comprising:
prioritising objective data indicative of objectives of an organisation;
generating macro data relating to a macro resource allocation plan relating to resource allocation requirements of the organisation based upon an analysis of the objective data in conjunction with historic resource usage data; and
generating micro data relating to resource allocation requirements of an element of the organisation based upon an analysis of the macro data and local data indicative of the resource allocation requirements of the element.

2. The method of claim 1, further comprising:
comparing at least one element of the micro data to at least one element of macro data to determine that the prioritization of objective data has been achieved.

3. The method of claim 1, further comprising:
comparing at least one element of the micro data to at least one element of the macro data to reduce an occurrence of duplication of resource allocation.

4. The method of claim 1, further comprising:
inputting data from a data structure corresponding to a catalogue of resources to a processor for the generation of the micro data.

5. The method of claim 1, further comprising:
generating the micro data using costing data of the resources to be allocated.

6. The method of claim 1, further comprising:
feeding back micro data into the generation of subsequent macro data.

7. The method of claim 1, wherein the local data comprises resource suitability metrics.

8. The method of claim 1, wherein the resource to be allocated is a training resource.

9. A resource allocation system, comprising:
central processing means; and
data storage means, the data storage means having historic resource usage data stored thereupon;
the central processing means being arranged to process resource priority data and historic resource usage data read from the data storage means, the processing means being further arranged to generate macro data relating to a macro resource allocation plan relating to resource allocation requirements of an organisation based upon the historic resource usage data and the resource priority data, the processing means being further arranged to generate micro data relating to resource allocation requirements of an element of the organisation based upon an analysis of the macro data and local data indicative of the resource allocation requirements of the element.

10. The system of claim 9, the central processing means being further arranged to:
compare at least one element of the micro data to at least one element of macro data to determine that the prioritization of objective data has been achieved.

11. The system of claim 9, the central processing means being further arranged to:
compare at least one element of the micro data to at least one element of the macro data to reduce an occurrence of duplication of resource allocation.

12. The system of claim 9, the central processing means being further arranged to:
input data from a data structure corresponding to a catalogue of resources to a processor for the generation of the micro data.

13. The system of claim 9, the central processing means being further arranged to:
generate the micro data using costing data of the resources to be allocated.

14. The system of claim 9, the central processing means being further arranged to:
feed back micro data into the generation of subsequent macro data.

15. The system of claim 9, wherein the local data comprises resource suitability metrics.

16. The system of claim 9, wherein the resource to be allocated is a training resource.

17. A program product stored on a computer readable medium for resource allocation, the computer readable medium comprising program code for:
prioritising objective data indicative of objectives of an organisation;
generating macro data relating to a macro resource allocation plan relating to resource allocation requirements of the organisation based upon an analysis of the objective data in conjunction with historic resource usage data; and
generating micro data relating to resource allocation requirements of an element of the organisation based upon an analysis of the macro data and local data indicative of the resource allocation requirements of the element.
